(19) United States
(12) Patent Application Publication
(10) Pub. No.: US 2004/0105021 A1
(43) Pub. Date: Jun. 3, 2004

(54) Color filter patterns for image sensors

(75) Inventor: Xiaoping Hu, San Jose, CA (US)

Correspondence Address: Bo-In Lin, 13445 Mandoli Drive, Los Altos Hills, CA, 94022, US

(73) Assignee: Bolymedia Holdings Co., Ltd.

(21) Appl. No.: 10/307,860

(22) Filed: Dec. 2, 2002

(51) Int. Cl. H04N 5/335

(52) U.S. Cl. 348/272

(57) ABSTRACT

Color filter patterns are invented for coating an array of imaging sensing elements so to obtain color images. Each of the color filter patterns consists of a luminance color Y and two other complementary or non-overlapping colors tessellated in a Bayer pattern, hexagonal pattern, YUV422 pattern, or other ordered tessellation. In two preferred embodiments of the invention, the color filter pattern differs from a conventional Bayer Pattern or a conventional hexagonal RGB pattern only in that the G color is replaced by a luminance color Y. The color filter for luminance Y can be realized by a transparent coating or no coating at all. In addition, the effective sensing areas of different colors are so chosen that desired signal-to-noise ratios are obtained by adjusting the color sensing areas and/or the sizes/curvatures of the micro lenses for the color pixels.

### BACKGROUND OF THE INVENTION

1. Field of the Invention

This invention relates to color image sensors that converts optical illumination into electrical signal arrays. More particularly, this invention is related to a new color filter pattern for an image sensor to improve color image sensing sensitivity and total image quality when perceived from human eyes by adjusting signal to noise ratio of different colors.

2. Description of the Related Art

Conventional technologies of designing and manufacturing color image sensors are still confronted with several technical difficulties and limitations. More specifically, color image sensors implemented with current technologies are still hindered by low level of sensing sensitivities, limited spatial resolutions and problems associated with color aliasing. Generally, an image sensor is applied for sensing either black and white or color images. The invention of this Application is related to color image sensors. There are several different technologies implemented for the color image sensors to generate color images from a single array of sensing elements. The most commonly used method in a color image sensor is to coat on the surface of a sensing array with a special pattern of different color filters. Conventional color image sensors apply two kinds of color filter patterns. FIG. 1 shows the first color filter pattern, i.e., the CYeMgG Pattern (or complementary color filter pattern), comprising C (Cyan), Ye (Yellow), Mg (Magenta), G (Green) pattern. FIGS. 2 and 3 show another kind of color filter patterns that utilize primary color filters, comprising R (Red), G (Green), and B (Blue), arranged in either a Bayer Pattern shown in FIG. 2 or a Hexagonal RGB Pattern as that shown in FIG. 3.

In a color image sensor implemented with the CYeMgG Pattern, the sensing element array is formed by a plurality of macro pixels, with each macro pixel consisting of 4 (elementary) pixels. Each pixel is coated with a single color, either C, or Ye, or Mg, or G. However, since the display industry commonly uses the primary color pattern, i.e., RGB (red, green, blue) colors, instead of a CYeMgG pattern, therefore, conversion of a CYeMgG color pattern into a RGB color pattern is carried out by performing the color matrix operations. Furthermore, since each pixel contains only one color (either C, or Ye, or Mg, or G), in order to obtain other (R, G, and B) colors for the same pixel, interpolation methods are used to generate the missing colors from neighboring pixels. For an image sensor implemented with a Bayer Pattern, the sensing element array is also formed by a plurality of macro pixels, with each macro pixel consisting of four pixels coated with either R, or G, or B color filter. A Bayer Pattern further requires that among each macro pixel, two pixels in either diagonal direction must be coated with G. Again since each pixel contains only one color (either R, or G, or B), in order to obtain other (two) colors for the same pixel, interpolation methods are used to generate the missing colors from neighboring pixels. Bayer pattern has four different geometric structures, with R, G, B located in different locations in the four pixels. Referring to FIG. 3 again for the Hexagonal RGB Pattern, a macro pixel contains only three sensing pixels of R, G, and B wherein each element is tessellated in hexagonal fashion. The R, G, B colors are equally and evenly placed in the sensing array. Interchanging the positions of two colors still form a Hexagonal RGB Pattern.

As discussed above, the color filter technologies that implement either the CYeMgG Pattern, Bayer Pattern, or Hexagonal RGB Pattern have at least three common technical difficulties. A first difficulty is the reduction of sensing sensitivities caused by the use of multiple layers of filters when compared to black and white sensors. The second difficulty is the reduction of effective spatial resolution due to the need of color interpolation. The requirement of color interpolation also introduces the third difficulty of color aliasing, which can be solved, typically, by low pass filtering, that however leads to reduction in image sharpness.

In order to improve the overall sensing sensitivity, U.S. Pat. No. 6,137,100 discloses a method by balancing the responses from sensing the three primary colors R, G, and B by taking into consideration of the fact that the color sensitivities of the photodiodes are different, specifically, the photodiodes are most sensitive to green then to red and lastly least sensitive to blue. The Patented method thus provides largest sensing area to blue pixels, and the second largest sensing area to red pixels, and the least sensing area to green pixels. However, the improvements in color sensing sensitivity achieved by this technique are still quite limited and also the methods are only applicable to the image sensor implemented with the color filters of RGB color patterns.

In order to avoid a requirement of color interpolations, a new color image sensor produced by Foveon is implemented with a three-layer image sensor as that shown in FIG. 4. This three-layer color sensor, designated by a model number as “X3 image sensor”, contains three layers of sensing array, with each layer sensing R, G, or B light spectrum respectively. The X3 image sensor is able to resolve the difficulties caused by color interpolation, but generates new problems due to the difference of the sensing sensitivities between different layers. The sensing sensitivity of a lower layer is smaller than that of the top layer. Therefore, the overall effective sensing sensitivity is further reduced. Additionally, the production yields are degraded as three layers of sensor are manufactured and assembled by using more complicate and time consuming manufacturing processes. Furthermore, there are three times of data to be processed and that places additional demand on data transfer and data processing rates and causes a significant increase of the production costs of the entire system implemented with this X3 image sensor.

Therefore, a need still exists to provide new and improved techniques and methods for designing and manufacturing a color image sensor to resolve these technical difficulties.

### SUMMARY OF THE PRESENT INVENTION

An object of this invention is to provide a new color filter pattern for color image sensors. The image sensor implemented with this new color filter pattern provides an improved color image sensing sensitivity and image sharpness compared with the traditional CYeMgG pattern, Bayer pattern, or hexagonal pattern. Therefore, the limitations and difficulties as those encountered in the prior art are resolved.

In a first aspect of the invention, the color filter patterns contain three colors, and one of these three colors is the luminance of the whole interested spectrum (e.g., the white color in the visible light spectrum) commonly designated as Y. This color is designated as the leading color. The color filter for luminance is realized by either a transparent coating or by applying no coating at all to the filter.

In a second aspect of the invention, besides the luminance filter, the image sensor includes two other color filters that can be of any two complementary colors or two primary colors, designated as secondary colors and labeled as S and Q for ease of description in this Application. For example, S can be Cyan, and Q can be Yellow, or S can be Red and Q be Blue. The color filter for a particular color, e.g., Yellow, is realized by a coating material or pigments that pass light spectrum corresponding to that particular color, e.g., Yellow. It is preferable that the each of two secondary colors corresponds to one, non-overlapping segment of the interested spectrum.

In a third aspect of the invention, irrespective of which form of tessellation is used, the leading color Y must be coated on at least the same number of pixels than each of the secondary colors S and Q while S is coated on about the same number of pixels as Q. The new color filter pattern may be applied in many different forms of tessellation including, but not restricted to, the conventional Bayer Pattern tessellation as that shown in FIG. 5, hexagonal tessellation as that shown in FIG. 7, or the YUV422 tessellation as that shown in FIG. 9.

In a fourth aspect of the invention, the sensing areas of the pixels or surface areas of the micro lenses on the pixels are designed such that the three kinds of sensing elements for Y, S, and Q colors have the desired signal to noise ratios (SNR) for the lighting condition of particular applications implemented with the image sensor of this invention.

Briefly in a preferred embodiment this invention discloses a method for generating a color filter pattern for a macro pixel of four elementary pixels. The color filter pattern includes a luminance color Y and two other colors S and Q organized in ordered tessellation. The tessellation includes Bayer tessellation and YUV422 tessellation. The YUV422 tessellation is widely used as YUV422 format in TV industry where YUV data are organized in YUYV interleave format. The method includes a step of coating the color filter pattern on top of a macro pixel with color Y on two elementary sensing pixel elements, and S and Q each on top of one elementary sensing pixel element. The method further includes a step of replicating the macro pixel with the said color filter pattern in the tessellation horizontally and vertically so to obtain an image sensor array.

These and other objects and advantages of the present invention will no doubt become obvious to those of ordinary skill in the art after having read the following detailed description of the preferred embodiments, which are illustrated in the various drawing figures.

### BRIEF DESCRIPTION OF THE DRAWINGS

FIG. 1 is a diagram of a CYeMgG color filter pattern;

FIG. 2 is a diagram of RGB Bayer color filter pattern and the variants;

FIG. 3 is a diagram of the Hexagonal RGB color filter pattern;

FIG. 4 is a diagram for showing the three-layer color filter technique implemented by Foveon, Inc. in a X3 image sensor;

FIG. 5 is a diagram for illustrating the YSQ color filter pattern according to a Bayer Tessellation and its variants according to the present invention;

FIG. 6 shows a preferred embodiment implemented with YBR color filters of this invention arranged according to a Bayer tessellations;

FIG. 7 is a diagram for illustrating an alternated preferred embodiment of this invention implemented with YSQ color filters arranged according to a Hexagonal Tessellation;

FIG. 8 is a diagram for illustrating an alternated preferred embodiment of this invention implemented with YBR color filters arranged according to a Hexagonal Tessellation;

FIG. 9 is a diagram of the newly invented YSQ color filter in different forms of YUV422 Tessellation;

FIG. 10 is a diagram for illustrating an alternated preferred embodiment of this invention implemented with YBR color filters arranged according to different forms of YUV422 Tessellation;

FIG. 11 is an area diagram for illustrating an area-based SNR adjustment method to adjust the SNRs of different color pixels to the desired values;

FIGS. 12A and 12B show cross sectional views of image sensors implemented with micro-lenses wherein the SNRs of different color pixels are adjusted to the desired values by applying a micro-lens based SNR adjustment method through size and curvature variations of micro-lenses to change effective sensing areas.

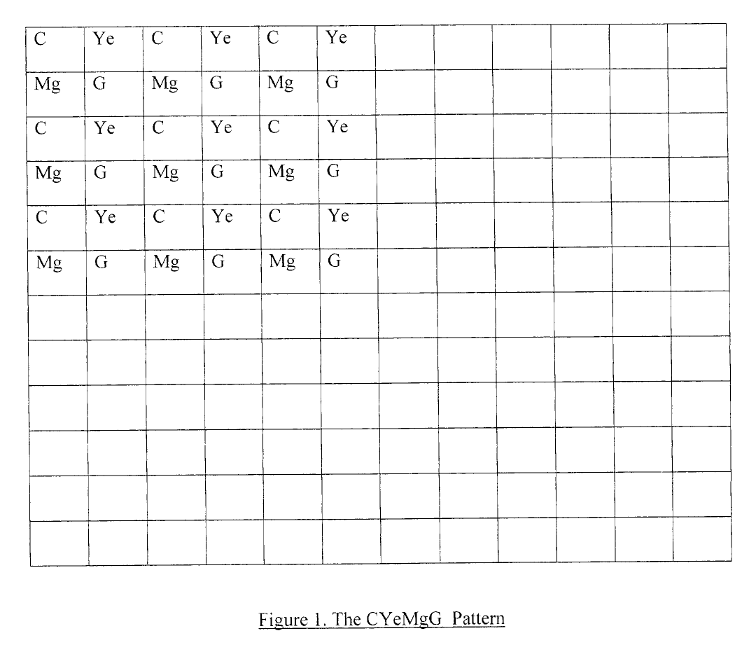

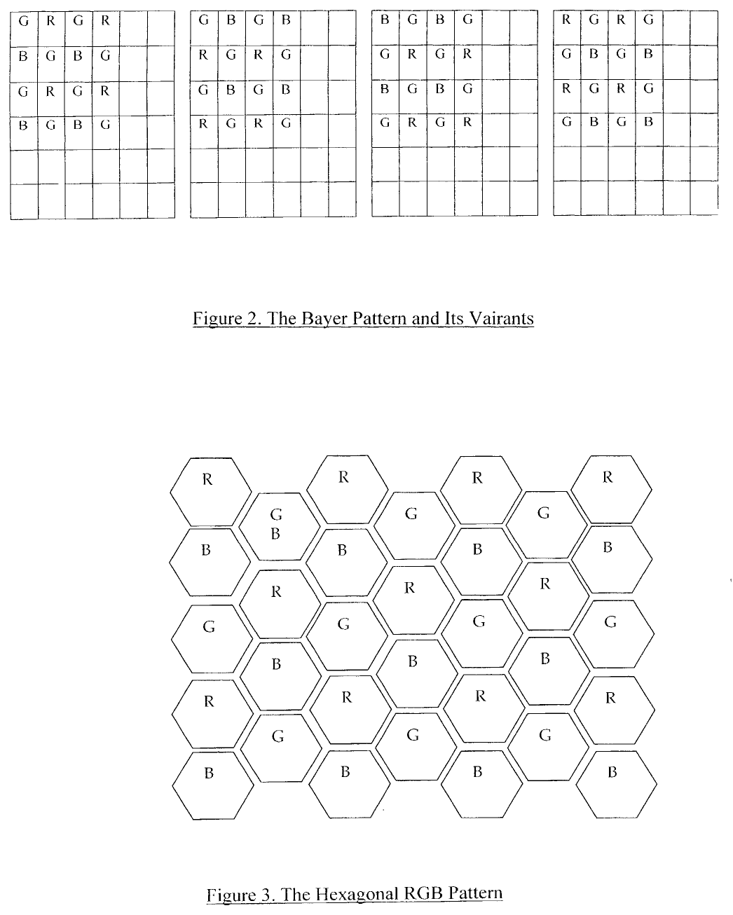

### DETAILED DESCRIPTION OF THE PREFERRED EMBODIMENTS

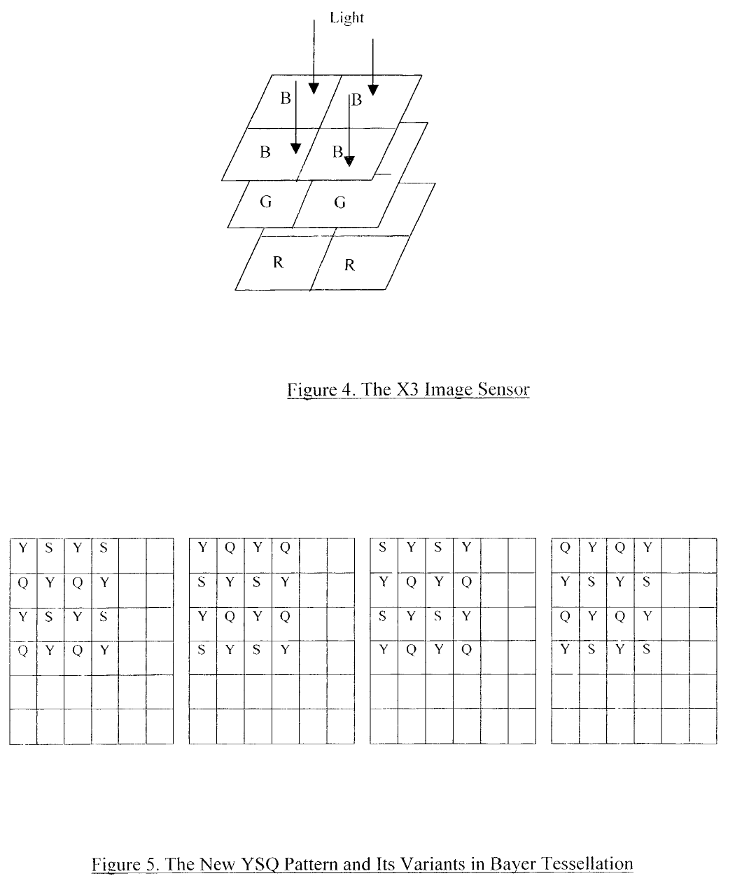

Referring to FIGS. 5A to 5D for four different color filter patterns respectively wherein each pattern includes a plurality of luminance filters designated as Y and two other color filters designated as S and Q. The Y color filters for sensing luminance, i.e., white light, are leading color filters and the S and Q filters are secondary color filters. The secondary color filters S and Q can be implemented with two complementary color filters or two primary color filters. Compared to the number of pixels coated with S and Q color filters, luminance color filters as shown are coated on number of pixels equal to or more than that coated on either the S or Q color filters. The number of pixels coated with S color filters is about the same as the number of pixels that coated with Q color filters.

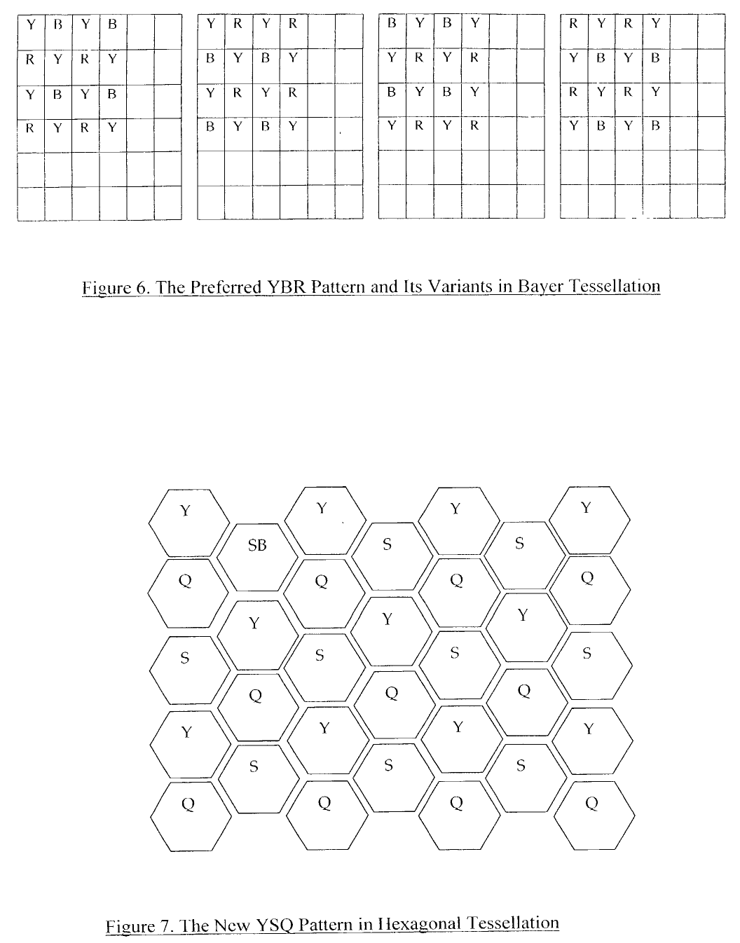

Referring to FIGS. 6A to 6D, two secondary colors S and Q are chosen to be Red and Blue respectively and Y, S, and Q are organized in a Bayer pattern. With this preferred embodiment, the color filter pattern differs from the conventional Bayer pattern only in that Green color filter is replaced by White color filter. Compared to the conventional Bayer pattern, the color sensor as shown in FIG. 6 requires significant changes to generate color images. The changes are required because the sensed three colors Y, S and Q, e.g., Y, R, and B, do not form a color space and they have never been used together in image sensors. For this reason, the color filter patterns as shown in FIGS. 5 and 6 require the internal color processing circuits to change correspondingly. Additionally, different color interpolation methods and matrix operations are needed to recover R, G, B colors from Bayer patterned now sensed as Y, S, Q, e.g., Y, B, R colors.

This seemingly simple change to the color filter patterns as shown in FIGS. 5 and 6, provides great advantages. First of all, the white color Y has much higher sensitivity than green color. The color image sensor configured according to the color filter pattern as shown can achieve much improved sensing sensitivity. Especially, since human eyes are more sensitive to luminance than chrominance and since there are more luminance components than other color components, for a human viewer the image sharpness is increased. Furthermore, since the U signal can be generated from (B-Y) and V signal can be generated from (R-Y) in a typical YUV color space, it is very easy to create a sensor that has direct YUV output. The easily available YUV signals also simplify the white balance and other color processing tasks. Particularly, since the conversion of the YUV color space to RGB space is a common knowledge, the sensed images generated as YBR colors according to this invention can be easily converted to the YUV colors. Then the RGB colors can be conveniently obtained from the YUV colors to produce color images with significant improved image qualities.

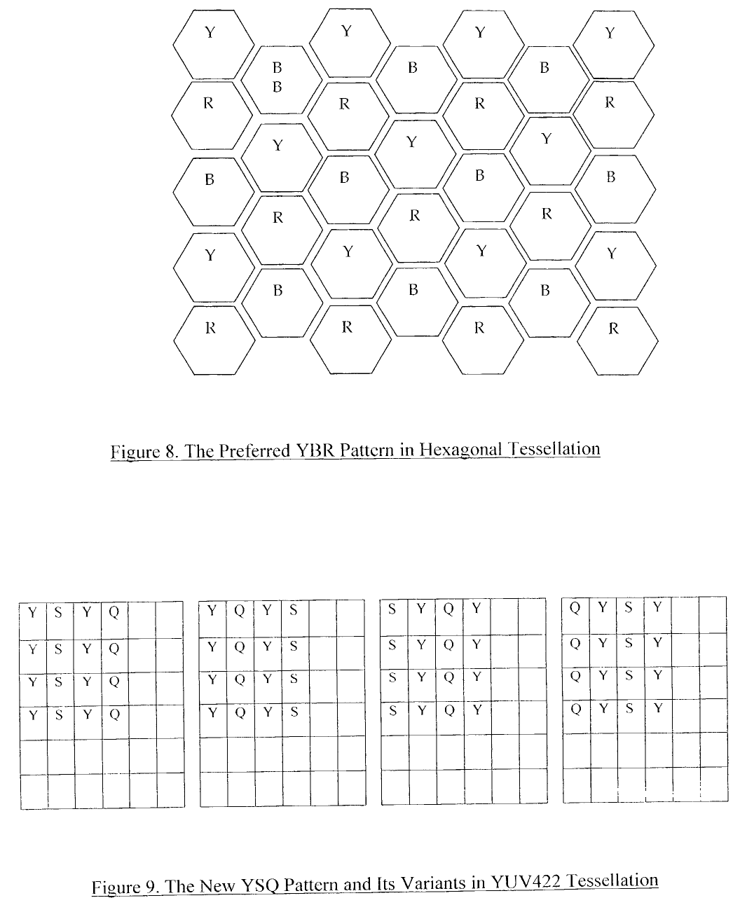

FIGS. 7 and 8 show a second set of preferred embodiment where the YSQ patterns are implemented in FIG. 7 according to a hexagonal tessellation. In FIG. 8, the YSQ color filter pattern is again arranged according to a hexagonal tessellation with S chosen as R and Q chosen as B. In this tessellation, Y, B, and R have about the same number of pixels. Meanwhile, in order to achieve better signal to noise ratios as will be discussed below, the sensing areas may be configured differently by providing either different filter areas or using micro lenses of different curvatures.

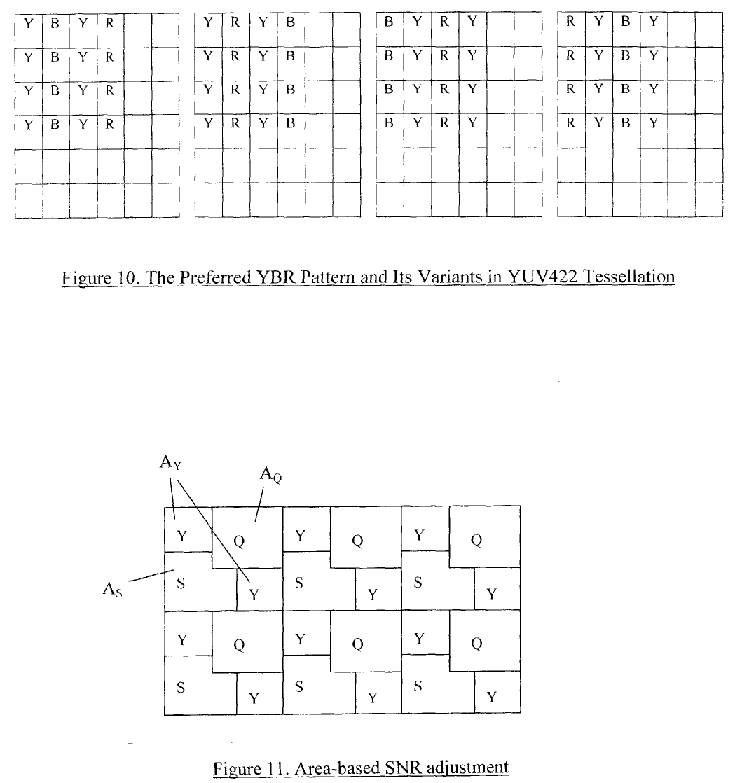

FIGS. 9 and 10 show a third set of preferred embodiment where the YSQ patterns are implemented in FIG. 9 according to a YUV422 tessellation. In FIG. 10, the YSQ color filter pattern is again arranged according to a YUV422 tessellation with S chosen as R and Q chosen as B. In this embodiment, the Y, B, and R colors are used for coating the pixels and these pixels are arranged in horizontally interleaved tessellation including either Y|B|Y|R, Y|R|Y|B, B|Y|R|Y, or R|Y|B|Y. Compared with the horizontal resolution, the vertical resolution is twice as higher for Y, and four times higher for B and R. In order to have a more balanced resolution, different methods are implemented. As a first exemplary implementation, the combined width of a macro pixel Y|B|Y|R, is arranged as twice as the height of a Y pixel. In a second exemplary implementation, instead of four pixels, two (R, G, B) pixels are produced through interpolation from each macro pixel Y|B|Y|R. Because of the similarity with the YUV422 format widely used in the TV industry, this preferred embodiment is particularly useful for video sensors. Even this embodiment has similar tessellations as that shown in U.S. Pat. No. 6,346,969, the invention as disclosed in this Application has superior image quality because of the improved effective sensing sensitivity by utilizing an improved Y-S-Q color filters instead of the conventional RGB color filters when compared with U.S. Pat. No. 6,346,969.

In all three different tessellations, as those shown in FIGS. 5 to 10, there are more or about same Y pixels when compared to S and Q pixels. Meanwhile, the S and Q pixels have about the same numbers of pixels.

The color image sensor has broad applications. For example, a digital camera can achieve immediate image quality improvement by utilizing a color image sensor as disclosed in this invention. Typically, a digital camera can easily achieve acceptable signal to noise ratio for an outdoor situation. However, in a low light condition such as the requirements for taking an indoor picture, conventional color image sensors often experience difficulties to provide sufficient image sensing sensitivity. In a low light environment, the SNR for a sensing element highly depends on the color coating and semiconductor processing technology of the sensing element (e.g., a photo diode). Normally, luminance Y has the highest SNR among all colors. Suppose that S has a higher SNR than Q. Let S_{Y}, S_{S}, S_{Q}, be the intrinsic SNR of the sensing element for color Y, S, and Q respectively. The intrinsic SNR of a color is defined as the SNR of the color at unit sensing area. Typically the signal to noise ratio can be calculated as:

S_{S}=S_{Y}/a, S_{Q}=S_{Y}/b, (b>=a>1.0).

If the desired SNRs for Y, S, and Q are D_{Y}, D_{S}, D_{Q} respectively with

D_{S}=D_{Y}/c, D_{Q}=D_{Y}/d,

Then sensing areas or the surface areas of the micro lenses for the Y, S, and Q pixels are chosen such that a S pixel collects a/c times more photons than a Y pixel, and a Q pixel collects b/d times more photons than a Y pixel. Furthermore, it is noted that:

a/c=(S_{Y}/S_{S})/(D_{Y}/D_{S})=(S_{Y}/D_{S})/(S_{S}D_{Y})

b/d=(S_{Y}/S_{Q})/(D_{Y}/D_{Q})(S_{Y}D_{Q})/(S_{Q}D_{Y})

The difference between sensing areas or surface areas of the micro lenses between a color pair S and Y, or Q and Y, is determined by both the desired and intrinsic SNRs of S and Y, or those of Q and Y. As shown in FIG. 11, the desired SNRs are achieved by adjusting surface areas or curvatures of the micro lenses for different colors. These drawings are exemplary and are not intended to limit the scope of this invention. The method of using the micro lenses for sensing areas adjustment can be either used independently or together with the sensing area adjustment method described below.

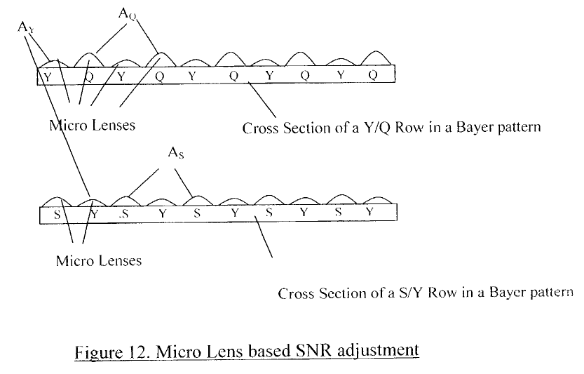

FIG. 12 shows a method that achieves desired SNRs by adjusting sensing areas of different color pixels. Compared to the disclosure made in U.S. Pat. No. 6,137,100, the SNR balancing techniques are different. The balancing techniques as disclosed by U.S. Pat. No. 6,137,100 is only applied to the conventional R-G-B color space and the Bayer tessellation, while the balance of this invention is applied to the Y-S-Q color space for all different kinds of tessellations. Furthermore, the SNR balancing method of this invention is not to equalize the color light photons received for R, G, and B pixels respectively, but to achieve the desired SNRs for Y, S, and Q respectively. The technique of this invention can produce better image quality for human eyes. The better image qualities are achieved because the human eyes are more sensitive to luminance than to chrominance. For this reason, the desired SNR for Y is higher than the desired SNRs for S and Q. Instead of adjusting even intensity of the R-G-B colors, a more sensible adjustment is to adjust the SNRs for better viewing as that most suitable for human eyes when looking from a human perspective. Other than the changes of planar sensing areas as shown in FIG. 12, additional sensing area adjustment can be achieved by using micro lenses on different color filters as that shown in FIG. 11 with micro lenses of different sizes and curvatures. The SNRs can therefore be flexibly adjusted to achieve best image quality by combining planar sensing area variations together with micro lens adjustments.

In summary, this invention discloses an improved color image sensor implemented with a color filter pattern that has a leading color, the luminance (or white color as in the visible light spectrum) Y of the whole interested spectrum, and two other secondary colors S and Q each corresponding one, non-overlapping segment of the interested spectrum. The secondary colors S and Q can be chosen from any two of the primary colors R, G, and B, or from any complementary color pairs out of C, Ye, Mg, and G, or from two other specifically desired colors (e.g., an infrared color and an ultraviolet color) for special applications. The leading color is applied to about the same or more number of pixels than each of the secondary colors. The color filter pattern can have any form of tessellation, including, but not restricted to, Bayer pattern tessellation, hexagonal tessellation, or YUV422 tessellation. The sensing areas and/or surface areas or curvature of the micro lenses of the color pixels are so chosen to achieve desired SNRs for the color pixels. This inventions thus uses a different color filter pattern to improve the sensitivity and increase image sharpness without the side effects of the X3 method. In addition, the method can be used to produce YUV sensors in very simple ways.

According to above descriptions and the illustrations provided in the drawings this invention disclosed a color image sensor. The color image sensor includes at least a first color filter for sensing a luminance from an entire spectrum relevant to the color image sensor. In a preferred embodiment, the color image sensor further includes a second filter of a second color and a third filter of a third color wherein the second and third colors correspond two non-overlapping segments of the entire spectrum. In a preferred embodiment, the color image sensor further includes a plurality of first color filters for sensing a luminance from an entire spectrum relevant to the color sensor. The color image sensor further includes a plurality of second filters of a second color and a plurality of third filter of a third color wherein the second and third colors correspond two non-overlapping segments of the entire spectrum. In a preferred embodiment, the color image sensor having more or an about same number of filters of the first color than the filters of the second color and the filters of the third color. In a preferred embodiment, the filters of the first color and the filters of the second and third colors are configured according to a Bayer tessellation. In a preferred embodiment, the filters of the first color and the filters of the second and third colors are configured according to a hexagonal tessellation. In a preferred embodiment, the filters of the white color and the filters of the second and third colors are configured according to a YUV422 tessellation. In a preferred embodiment, the first color filter is for sensing a luminance from an entire spectrum of a visible color for a human eye. In a preferred embodiment, the color image sensor further includes a second filter of a second color, and a third filter of a third color wherein the second and third colors are two complementary visible colors for a human eye. In a preferred embodiment, the color image sensor further includes a second filter of a second color, and a third filter of a third color wherein the second and third colors are two different primary visible colors for a human eye. In a preferred embodiment, the color image sensor further includes a second filter of a red color, and a third filter of a blue color.

Furthermore, this invention discloses a color image sensor that includes a plurality of color filters of different colors wherein a tessellation of the color filters of the different colors is configured for achieving substantially a desired signal-to-noise ratio for each of the colors.

This invention also discloses a method for sensing a color image. The method includes a step of employing at least a first color filter for sensing a luminance from an entire spectrum relevant to the color image. In a preferred embodiment, the method further includes a step of employing a second filter of a second color and a third filter of a third color wherein the second and third colors correspond two non-overlapping segments of the entire spectrum. In another preferred embodiment, the method further includes a step of employing a plurality of color filters of different colors to configure a tessellation of the color filters of the different colors for achieving substantially a desired signal-to-noise ratio for each of the colors.

Although the present invention has been described in terms of the presently preferred embodiments, it is to be understood that such disclosure is not to be interpreted as limiting. Various alterations and modifications will no doubt become apparent to those skilled in the art after reading the above disclosure. Accordingly, it is intended that the appended claims be interpreted as covering all alterations and modifications as fall within the true spirit and scope of the invention.

1. A color image sensor comprising:
at least a first color filter for sensing a luminance from an entire spectrum relevant to said color image sensor.

2. The color image sensor of claim 1 further comprising:
a second filter of a second color and a third filter of a third color wherein said second and third colors correspond two non-overlapping segments of said entire spectrum.

3. The color image sensor of claim 1 further comprising:
a plurality of first color filters for sensing a luminance from an entire spectrum relevant to said color sensor;
a plurality of second filters of a second color and a plurality of third filter of a third color wherein said second and third colors correspond two non-overlapping segments of said entire spectrum.

4. The color image sensor of claim 3 wherein:
said color image sensor having more or an about same number of filters of said first color than said filters of said second color and said filters of said third color.

5. The color image sensor of claim 3 wherein:
said filters of said first color and said filters of said second and third colors are configured according to a Bayer tessellation.

6. The color image sensor of claim 3 wherein:
said filters of said first color and said filters of said second and third colors are configured according to a hexagonal tessellation.

7. The color image sensor of claim 3 wherein:
said filters of said white color and said filters of said second and third colors are configured according to a YUV422 tessellation.

8. The color image sensor of claim 1 wherein:
said first color filter is for sensing a luminance from an entire spectrum of a visible color for a human eye.

9. The color image sensor of claim 8 further comprising:
a second filter of a second color, and a third filter of a third color wherein said second and third colors are two complementary visible colors for a human eye.

10. The color image sensor of claim 8 further comprising:
a second filter of a second color, and a third filter of a third color wherein said second and third colors are two different primary visible colors for a human eye.

11. The color image sensor of claim 8 further comprising:
a second filter of a red color, and a third filter of a blue color.

12. The color image sensor of claim 8 further comprising:
a plurality of white color filters for sensing a luminance from an entire spectrum of a visible color for a human eye;
a plurality of second filters of a second color and a plurality of third filter of a third color wherein said third color is a complementary color of said second color.

13. The color image sensor of claim 12 wherein:
said color image sensor having more or an about same number of filters of said white color than said filters of said second color and said filters of said third color.

14. The color image sensor of claim 12 wherein:
said filters of said white color and said filters of said second and third colors are configured according to a Bayer tessellation.

15. The color image sensor of claim 12 wherein:
said filters of said white color and said filters of said second and third colors are configured according to a hexagonal tessellation.

16. The color image sensor of claim 12 wherein:
said filters of said white color and said filters of said second and third colors are configured according to a YUV422 tessellation.

17. The color image sensor of claim 8 further comprising:
a plurality of white color filters for sensing a luminance from an entire spectrum of a visible color for a human eye;
a plurality of second filters of a second color and a plurality of third filter of a third color wherein said second and third colors are two different primary colors.

18. The color image sensor of claim 17 wherein:
said color image sensor having more or an about same number of filters of said white color than said filters of said second color and said filters of said third color.

19. The color image sensor of claim 17 wherein:
said filters of said white color and said filters of said second and third colors are configured according to a Bayer tessellation.

20. The color image sensor of claim 17 wherein:
said filters of said white color and said filters of said second and third colors are configured according to a hexagonal tessellation.

21. The color image sensor of claim 17 wherein:
said filters of said white color and said filters of said second and third colors are configured according to a YUV422 tessellation.

22. The color image sensor of claim 3 wherein:
said color image sensor is configured with a set of desired signal-to-noise ratios of said first color and said second and third colors by adjusting a first area covered by said first filters of said first color and a second and third areas covered by said second and third filters of said second and third colors respectfully.

23. The color image sensor of claim 3 wherein:
said color image sensor is configured with a set of desired signal-to-noise ratios of said first color and said second and third colors by adjusting a first effective sensing area of the micro lens of said first filters of said first color and a second and third effective sensing areas of said second and third filters of said second and third colors respectfully wherein each of said second and third filters covered by a micro lens.

24. The color image sensor of claim 12 wherein:
said color image sensor is configured with a set of desired signal-to-noise ratios of said white color and said second and third colors by adjusting a first area covered by said first filters of said white color and a second and third areas covered by said second and third filters of said second and third colors respectfully.

25. The color image sensor of claim 12 wherein:
said color image sensor is configured with a set of desired signal-to-noise ratios of said white color and said second and third colors by adjusting a first effective sensing area of the micro lens of said first filters of said white color and a second and third effective sensing areas of said second and third filters of said second and third colors respectfully wherein each of said second and third filters covered by a micro lens.

26. The color image sensor of claim 17 wherein:
said color image sensor is configured with a set of desired signal-to-noise ratios of said white color and said second and third colors by adjusting a first area covered by said first filters of said white color and a second and third areas covered by said second and third filters of said second and third colors respectfully.

27. The color image sensor of claim 17 wherein:
said color image sensor is configured with a set of desired signal-to-noise ratios of said white color and said second and third colors by adjusting a first effective sensing area of the micro lens of said first filters of said white color and a second and third effective sensing areas of the micro lenses of said second and third filters of said second and third colors respectfully.

28. A color image sensor comprising:
a plurality of color filters of different colors wherein a tessellation of said color filters of said different colors is configured for achieving substantially a desired signal-to-noise ratio for each of said colors.

29. A method for sensing a color image comprising: employing at least a first color filter for sensing a luminance from an entire spectrum relevant to said color image.

30. The method of claim 29 further comprising:
employing a second filter of a second color and a third filter of a third color wherein said second and third colors correspond two non-overlapping segments of said entire spectrum. 31. A method for sensing a color image comprising:
employing a plurality of color filters of different colors to configure a tessellation of said color filters of said different colors for achieving substantially a desired signal-to-noise ratio for each of said colors.
